(19) United States
(12) Patent Application Publication
(10) Pub. No.: US 2006/0288809 A1
(43) Pub. Date: Dec. 28, 2006

(54) Rack and pinion transmission

(76) Inventor: Yakov Fleytman, Lake Orion, MI (US)

Correspondence Address: YAKOV FLEYTMAN, 6358 CHESNUT PARKWAY, FLOWERY BRANCH, GA, 30542, US

(21) Appl. No.: 11/165,477

(22) Filed: Jun. 23, 2005

(51) Int. Cl. F16H 27/02

(52) U.S. Cl. 74/89.11

(57) ABSTRACT

A rack and pinion transmission is provided with a unique enveloping worm, spiral bevel or hypoid pinion in the engagement with a rack. These pinions have tapered shape which is modified by reposition of drive or/and coast face of said thread from original position. The new rack and pinion transmission is more efficient, quite and compact than conventional systems with worm or helical gear pinions. The rack and pinion transmission of the present invention is easily manufactured.

### FIELD OF THE INVENTION

This invention relates to metalworking machines and machine tools, utilizing transferring rotational motion of an input shaft into motion of output member similar to worm screw and worm rack mechanisms to provide precise component movement within those machines. Certain applications may be outside of these fields, like power windows, doors or seats, power steering systems and many industrial applications.

### BACKGROUND OF THE INVENTION

Worm drive mechanisms have been used to move machinery components for many years. It is an effective method for transmitting rotary motion into linear motion. The axes of the worm gears and rack are however, spaced apart, and between them define a moment arm which may cause a slight non-linear arrangement in the worm, thereby creating extraneous forces, diminishing the efficiency that would otherwise be useful to move the components.

A typical worm and rack arrangement is shown in the machine tool art in U.S. Pat. No. 3,097,568 to Kampmeier, wherein a worm is disposed alongside and meshes with the teeth of a horizontal rack bolted to a ram. Rotation of the worm forces the rack and ram in a linear path.

This type of mechanism is also shown in U.S. Pat. No. 3,659,474 to Neugebauer, wherein a pair of worm gears are adapted to a single worm rack, the worm rack being attached to a table which is used to support a work piece during its milling operation. The single worm rack on one side of the worm, as shown in the prior art, generates a radial component of force within the worm gear as a result of its thrust against a single rack. This radial component of force is a moment arm which causes deflection within the worm gear, and may cause undesirable loads on the machine carriage and its associated bearings. This bending force, in addition to the axial thrust through the worm created by the interaction of the worm gear shape on a single rack, effectuates the loading and deflection thereof and otherwise necessitates heavier components, bearings, motors and the like. The drive mechanism of the prior art also induces strain within itself, because slight deviations in the worm rack or worm gear are transmitted into their support systems which do not allow deflections therewith.

In another patent of U.S. Pat. No. 4,148,227 to Neugebauer worm and worm-rack have hydrostatic lubrication. The teeth of the worm and the worm-rack have a trapezoidal cross-section and lubricating oil is supplied through openings in the toothed flanks. The half angle formed between each of the toothed flanks and the line of action to the axis of the worm is limited solely to the range of 6 to 10 degrees and the lead angle is in the range of 2 to 10 degrees. This patent produces good lubrication that reduces friction between moving elements but realization of it significantly increases the complexity of the drive system.

Another well developed area of using mechanisms to transfer rotation motion into output motion is rack and pinion steering systems. Pinion gear of such steering system is usually a cylindrical helical gear. The movement of contact pattern in all rack and pinion transmissions across the rack tooth or from the root to the tip or from the tip to the root depending on the direction of rotation. This motion consists of sliding and small amount of rolling. But sliding and rolling velocities are orthogonal which decreases driving efficiency. Between meshed surfaces there is high contact pressure with high sliding velocity and poor lubrication. For angle near 90 degrees between pinion shaft and direction of rack motion the contact ratio is very small.

It is an object of the present invention to provide the transmission that increases mechanical efficiency for transferring rotational motion into linear motion and vice versa, with reduced component dimensions for the same work load.

### SUMMARY OF THE INVENTION

In right angle power transmission systems for transferring rotation motion into rotation motion for high ratio applications with ratio 5:1 or higher worm and helical gear transmissions have been used. They have exactly the same pinions that are usually used for rack and pinion systems. For low ratio right angle transmission system spiral bevel or hypoid drive systems and recently developed (Fleytman U.S. Pat. No. 6,148,683) modified enveloping worm transmission with less than one revolution of threads are commonly used. What these transmission systems have in common is a pinion gear with threads with working surfaces having concave shape on one side and convex shape on the opposite side. The pinion of these low ratio transmission has a tapered shape and these pinions are not used in rack and pinion systems. Tapered pinion transmissions in mesh with a rack have limitations of transferring torque due to an edge contact of the thread, which limits the torque/force capacity of such systems. Modification of working concave and convex surfaces of the threads helps to improve contact pattern. It is more practical to use enveloping worm, spiral bevel or hypoid pinions with thread surfaces that were generated by special cutting technology that has been developed very well for these types of right angle gears. They have working surfaces located in the original position. For example, enveloping worm thread shape generated by the base shape of the involutes cutter which rolls around the base circle where the pinion tooth section is always on the same angle to the gear circle. It is better to keep the original enveloping worm's thread surface or spiral bevel pinion and hypoid pinion surfaces unattached but to change the orientation of working surfaces of the thread. By changing the original position of working surfaces this modification produces motion of contact pattern along the rack tooth line: from one side to another. This is sliding and rolling motion, but rolling and sliding are collinear thus improving driving efficiency of the new rack and pinion transmission, compared to that of a well-known rack and pinion gearsets. After modifying the tapered pinion threads the contact area becomes the surface or close to the surface area compared to a well known rack and pinion systems with point or close to line contact area.

Thus, the present invention can replace rack and pinion gearing in many applications by reason of high efficiency and high load capacity. It is possible to change the angular position between the axis of enveloping worm or tapered pinion rotation and direction of rack linear motion, so instead of 90 degrees it could be any angle up to zero degrees. With angle close to zero degrees tapered or enveloping worm and rack transmission could be self-locking, where we can provide motion from a pinion to the rack, but linear motion of rack cannot rotate the pinion.

It should be understood however that the detailed description and specific examples, while indicating preferred embodiments of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is an isometric view of the enveloping worm pinion and rack transmission with an enveloping worm with less than one revolution of threads;

FIG. 2 is a plan view of the enveloping worm pinion and rack transmission with an enveloping worm with less than one revolution of threads;

FIG. 3 is an isometric view of the enveloping worm pinion and rack transmission with an enveloping worm with less than one revolution of threads having double tapered shape with continuous threads in one direction;

FIG. 4 is a plan view of the enveloping worm pinion and rack transmission with an enveloping worm with less than one revolution of threads having double tapered shape with continuous threads in one direction;

FIG. 5 is an isometric view of the enveloping worm and pinion rack transmission with an enveloping worm with less than one revolution of threads having double tapered shape with threads in opposite directions;

FIG. 6 is a plan view of the enveloping worm pinion and rack transmission with an enveloping worm with less than one revolution of threads having double tapered shape with threads in opposite directions;

FIG. 7 is an isometric view of the spiral pinion and rack transmission with threads having tapered shape;

FIG. 8 is a plan view of the spiral pinion and rack transmission with threads having tapered shape;

FIG. 9 is an isometric view of the spiral pinion and rack transmission with threads having double tapered shape going in opposite directions;

FIG. 10 is a plan view of the spiral pinion and rack transmission with threads having double tapered shape going in opposite directions;

FIG. 11 is an isometric view of the hypoid pinion and rack transmission with threads having tapered shape;

FIG. 12 is a plan view of the hypoid pinion and rack transmission with threads having tapered shape.

FIG. 13 is a view of a 360 degree (one revolution) thread that is generated by using a base circle;

FIG. 14 is a view of a 360 degree thread of an enveloping worm marked every 90 degrees of revolution;

FIG. 15 is a view of the convex surface extracted from 180 degree surface of thread;

FIG. 16 is combination of worm thread surface displacements for part A of the thread;

FIG. 17 is combination of worm thread surface displacements for part B of the thread;

FIG. 18 is combination of worm thread surface displacements for parts A and B of the thread;

FIG. 19 shows a machine setting for manufacturing modified thread of an enveloping worm.

FIG. 20 shows an enveloping pinion in mesh with helical gear.

FIG. 21 shows an enveloping pinion in mesh with helical rack.

FIG. 22 shows a rack and pinion with an angle between said pinion axis of rotation and a direction of movement of said rack is 90 degrees or less.

FIG. 23 shows a rack and pinion with an angle between said pinion axis of rotation and a direction of movement of said rack is zero degrees.

FIG. 24 shows a rack and pinion with an angle between said pinion axis of rotation and a direction of movement of said rack.

FIG. 25 shows a rack and pinion with a variable angle between said pinion axis of rotation and a direction of movement of said rack.

### DETAILED DESCRIPTION OF THE PREFERRED EMBODIMENTS

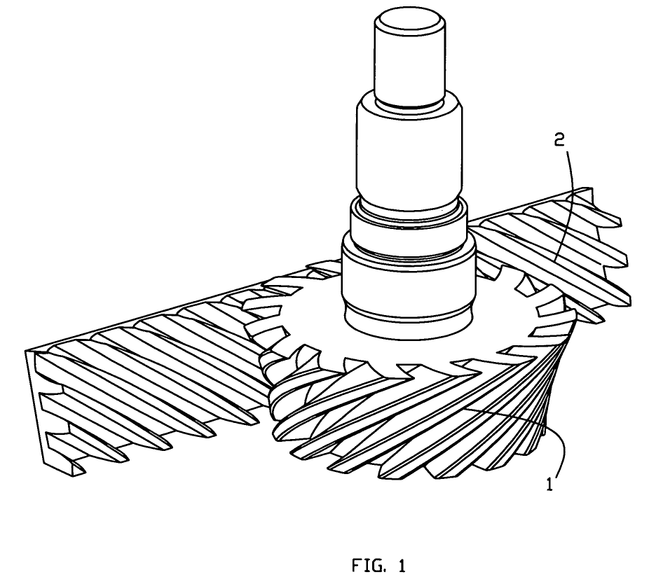

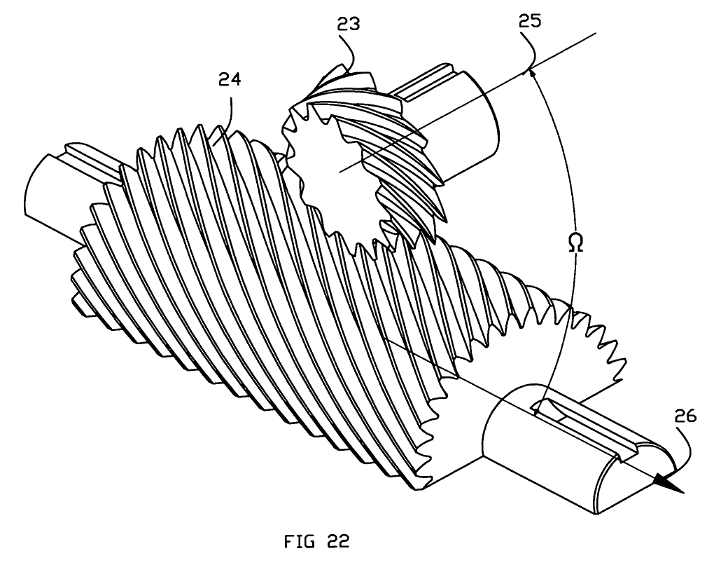

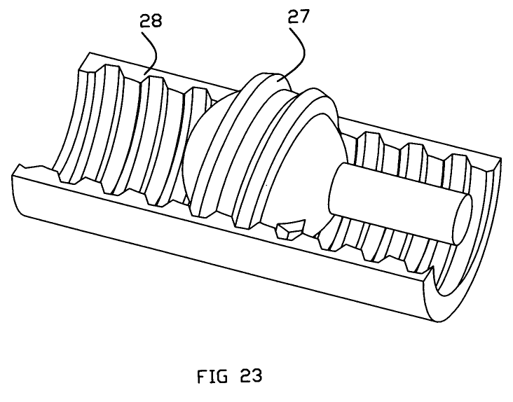

The following discussion relating to FIGS. 1-25 provides a detailed description of the present invention.

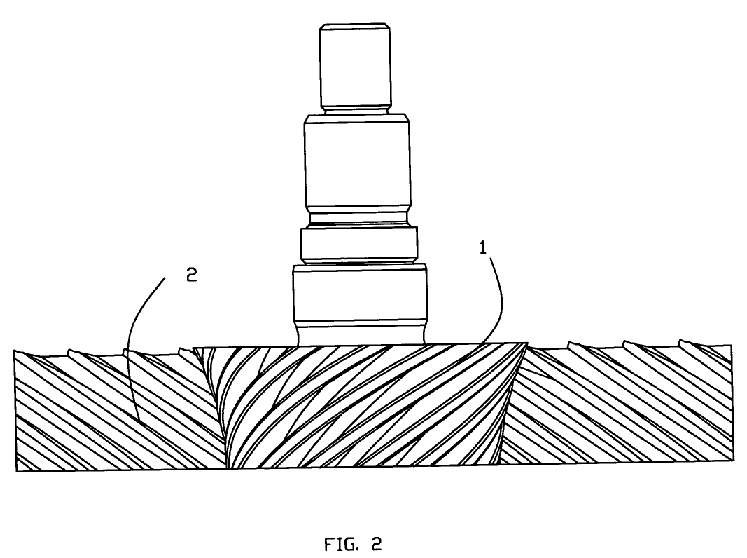

Referring now to the drawings, one embodiment of a rack and enveloping worm pinion transmission of the present invention is illustrated in FIG. 1 and FIG. 2. It consists of enveloping worm 1 which engages with rack 2. Rack 2 has linear direction profile but could be with a curvature profile which is varies in horizontal or/and vertical directions. Enveloping worm 1 when it has less than 360 degrees of thread revolution having tapered shape. This shape is useful for mass production of enveloping worm pinion rack transmission by forging, casting or injection molding.

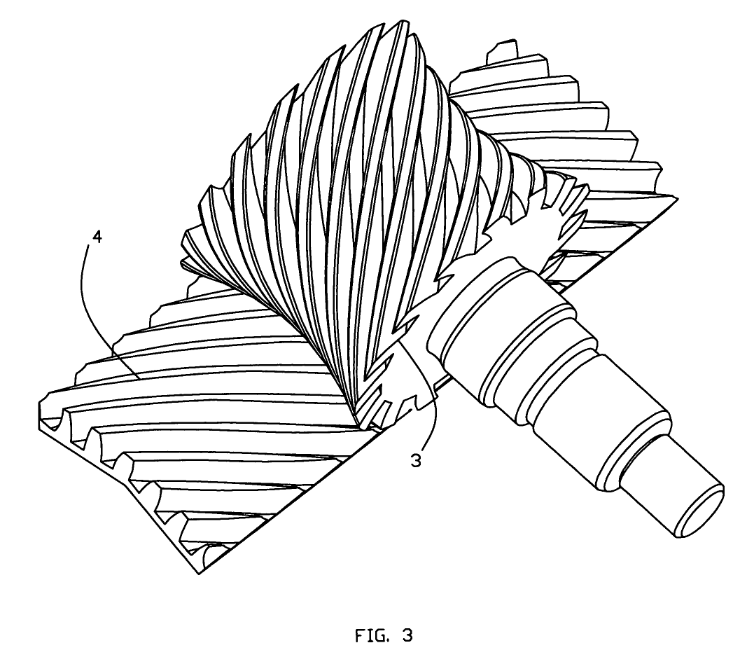

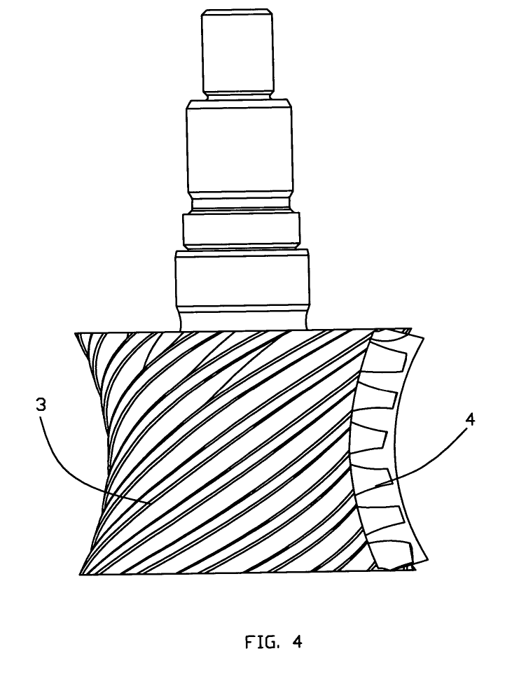

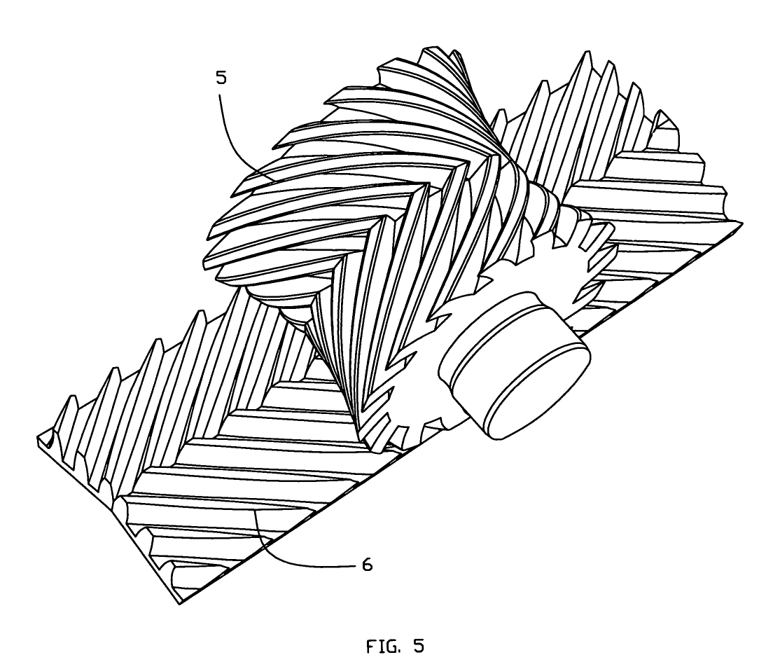

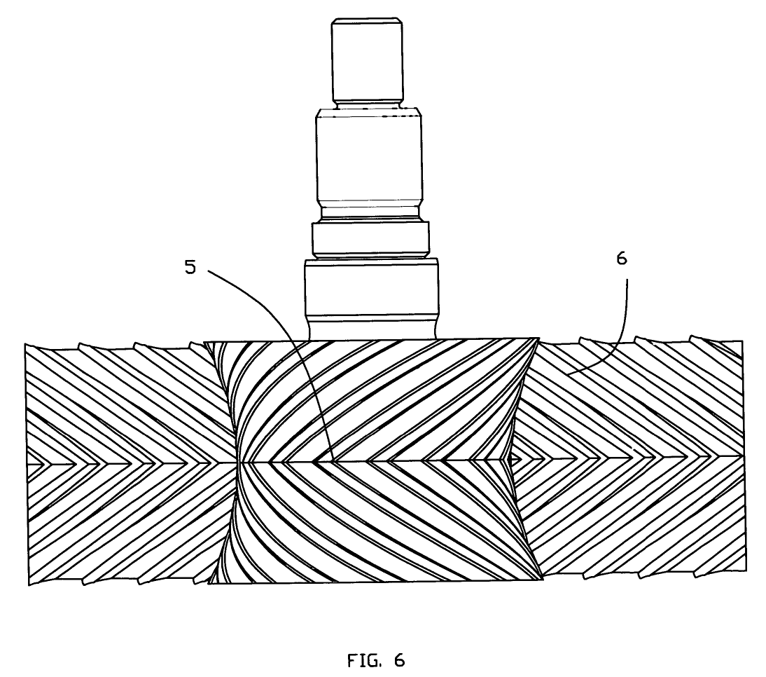

In FIG. 3 and FIG. 4 we have two tapered enveloping pinions attached together on the same axis of rotation with threads positioned in the same direction. Enveloping pinion 3 and rack 4 are wide with double toothed rack. In FIG. 5 and FIG. 6 we have two tapered enveloping worm pinions attached together on the same axis of rotation with threads positioned in opposite directions. Enveloping pinion 5 and rack 6 are also wide compared to enveloping pinion 1 and rack 2.

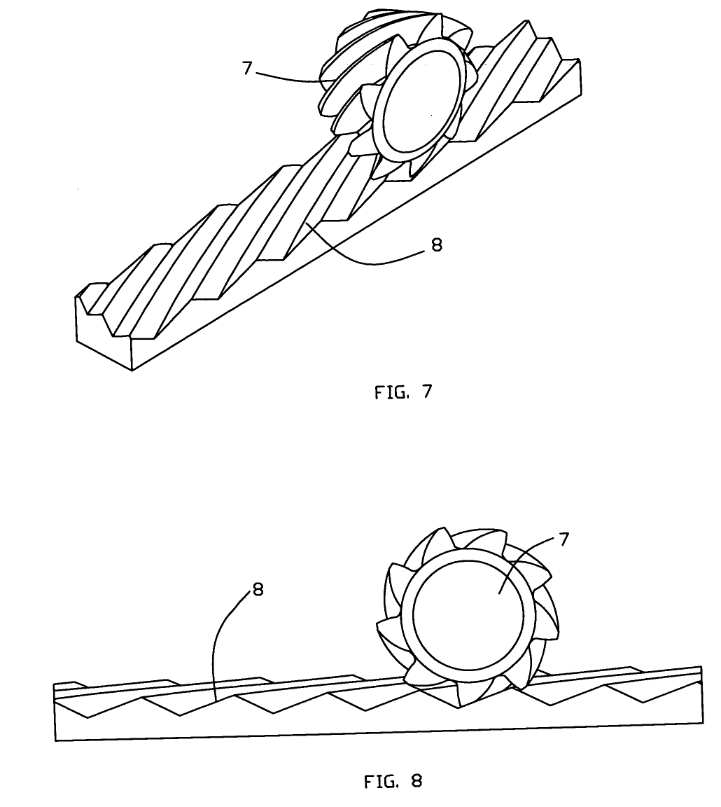

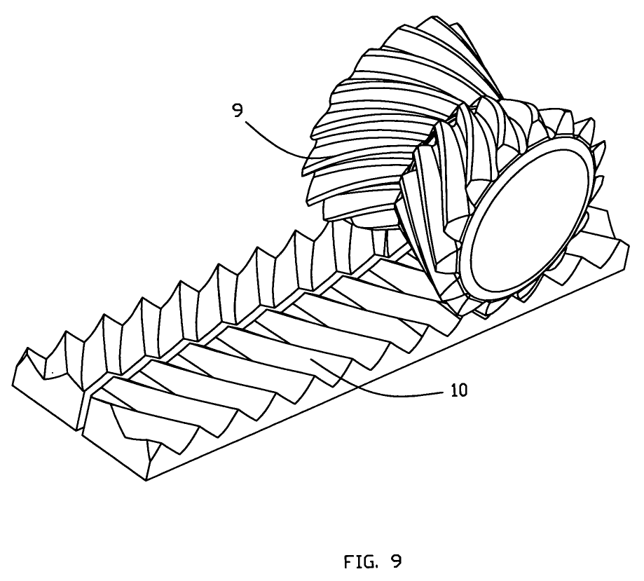

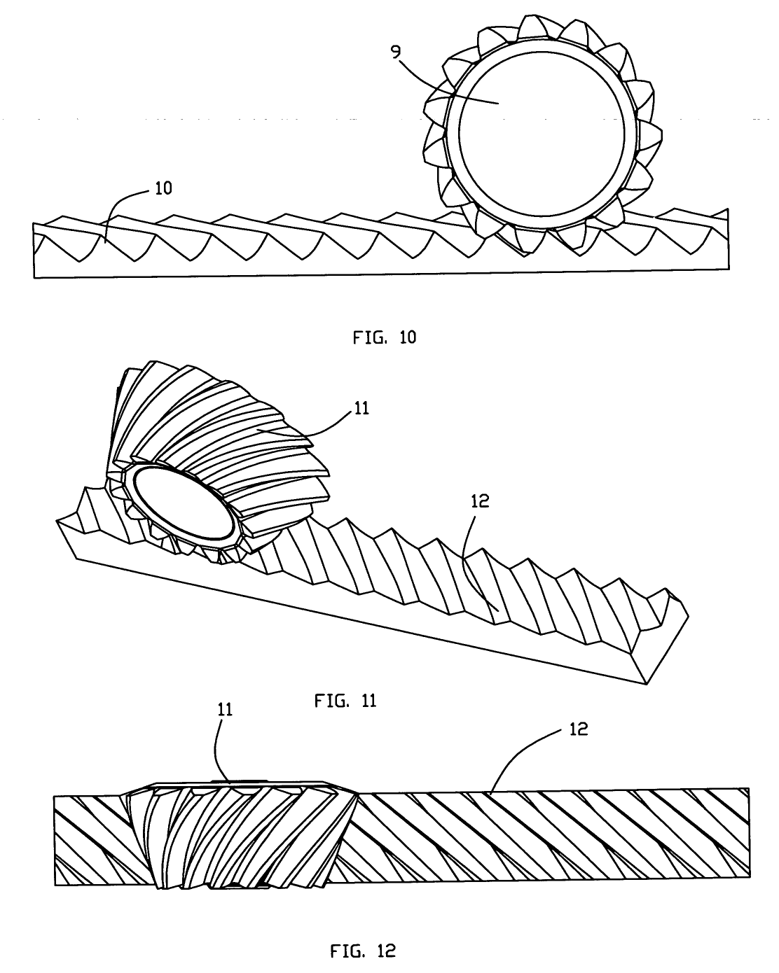

FIG. 7 and FIG. 8 shows a modified spiral bevel pinion 7 in mesh with rack 8. In FIG. 9 and FIG. 10 we have two tapered spiral bevel pinions attached together on the same axis of rotation with threads positioned in opposite directions. Enveloping pinion 9 and rack 10 are also wide compared to enveloping pinion 7 and rack 8. FIG. 11 and FIG. 12 shows a modified hypoid bevel pinion 11 in mesh with rack 12.

FIG. 13 is a 360 degree (one revolution) view of thread 13 that is generated by using a base circle 14. The coordinate system X, Y, Z is located in the center of the base circle 14. Thread 13 is located symmetric to plane ZY. We have the initial position of the thread, where the thread is usually used in double enveloping worm worm/gear transmissions and we have the original position of surfaces on one side of the thread and on another side (drive and coast surfaces ) of the enveloping worm. Initial position of the enveloping worm thread is the position of the thread where it was generated by rolling a cutter around base circle with simultaneous rotation of enveloping worm blank.

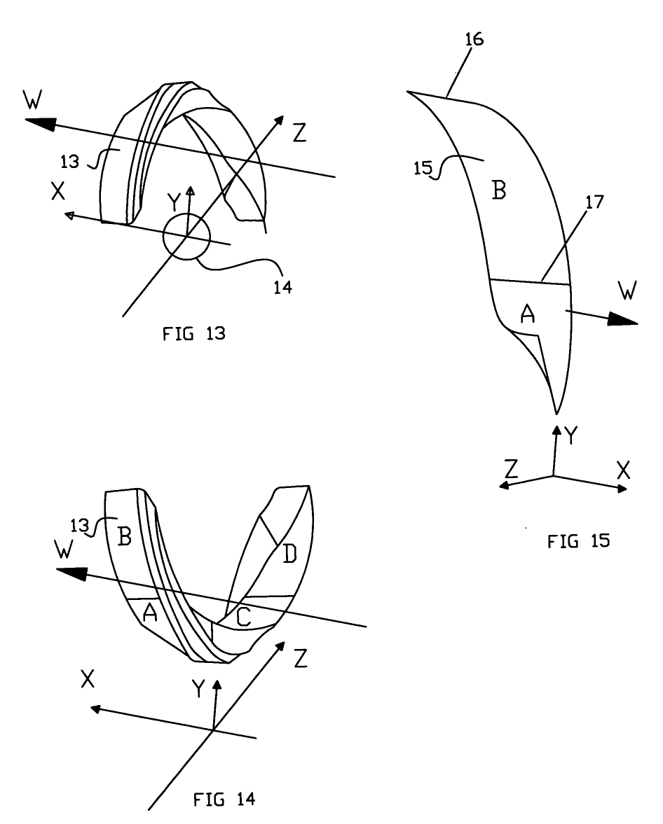

FIG. 14 is a location of generated thread 13 with drive and coast surfaces after rolling straight cutting edge around base circle 14. The enveloping worm surfaces on thread 13 are in the original position. FIG. 14 is a view of thread 13 in location used for further modifications of the thread's surfaces. The location of the enveloping worm thread 13 could be in any angular location around the axis of rotation of the enveloping worm. In other words, it could be in any location of the enveloping worm thread where it is engaged by at least one tooth of the worm gear for the cycle of rotation around the enveloping worm axis of rotation. For example, the location of the thread 13 in FIG. 14 is rotated 180 degrees around worm axis of rotation W from that in FIG. 13. The thread is split into two halves with parts AB and CD using XY plane. Each half of thread 13 was further split into parts A, B, C and D using plane locating on the axes W of thread 13 (worm) rotation, parallel to plane ZY. Parts A and C have a smaller lead angle than parts B and D. This thread has a convex surface on parts A and B (marks A and B are placed on the convex surfaces) and a concave surface on parts C and D (marks C and D are placed on the concave surfaces). Each convex surface on one side of the thread becomes the concave surface and each concave surface on another side of the thread becomes the convex surface. FIG. 15 is a view of the convex surface 15 extracted from parts A and B of the thread 13. Part B has a bigger lead angle than part A. Surface 15 has edge 16 and edge 17 between parts A and B. Our goal is to able to generate enveloping worm thread surface by the shape of the cutter, which rolls around the base circle and then to be able to generate tooth rack gear shape by surface of the enveloping thread, not the edge of the thread. The surface of rack teeth should be generated by the surface of the thread or threads of the enveloping worm using both sides of the thread: convex and concave. To be able to generate the enveloping worm thread we must generate the enveloping thread surfaces separately; for concave enveloping worm surface from one position of the cutting plane and for the convex enveloping worm surface from another position of the cutting plane. A computer model simulation can be utilized to generate the surface of the rack tooth by using enveloping pinion thread. The rack can also be formed using known techniques such as hobbing. When rack teeth are generated by the surface of the enveloping worm threads having different lengths (shortened), the shapes of the rack teeth are different.

We used enveloping worm pinion with 15 threads that was designed for the mesh with worm gear having 48 teeth and center distance of 65 mm. Pitch radius of the gear is 46 mm; base circle of the worm is 17.0 mm. The angle of the blade to cut enveloping worm thread is 7 degrees. To generate rack with this enveloping worm we rotated enveloping worm and simultaneously moved blank of the rack in linear direction in proportion for every 1 degree of rotation of enveloping pinion rack moved 1 mm.

The principles of the worm thread modification could be applied to any degree of revolution of the worm thread: less than 90, 90, less than 180, 180, less than 360, 360 and more than one revolution of the thread. Longer worm thread has better contact ratio. From manufacturing position it is more convenient to have asymmetric worm thread. The following are examples of modifications of thread surfaces of an enveloping worm 13. The enveloping worm with 180 degrees or less of a thread revolution with concave surface on one side of the thread and convex surface on an opposite side (these are parts A and B on the thread) has only the convex surface of the worm thread modified by repositioning from its original location.

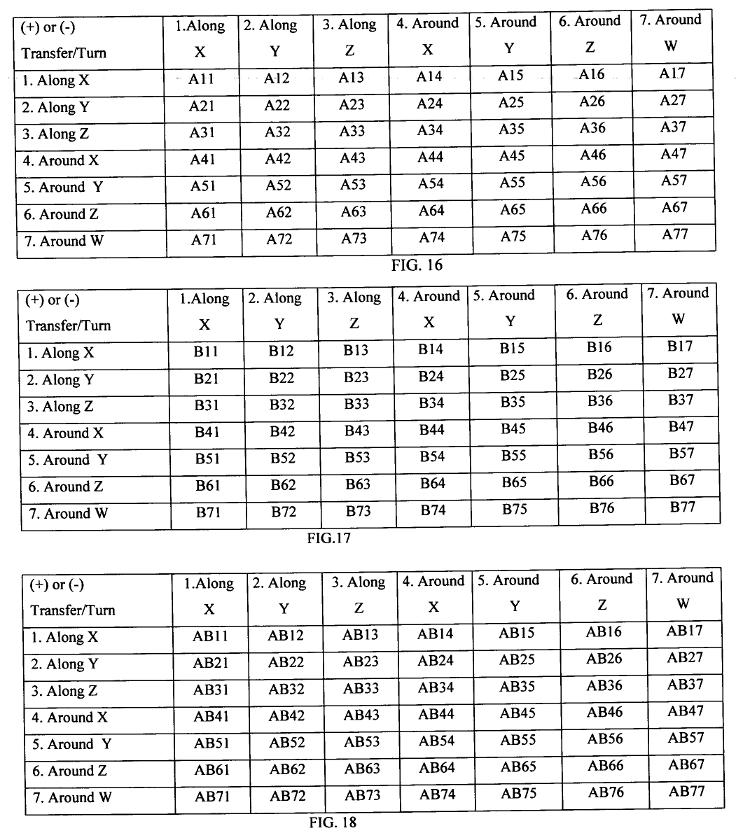

The repositioning could be done using various approaches. FIG. 16, FIG. 17 and FIG. 18 show possible combinations of such reposition for part A, for part B and for parts A and B. The magnitude and direction of the reposition could be defined for each design configuration (ratio, center distance, number of an enveloping threads, number of worm gear teeth) and initial angular position of a thread relative to its axis of rotation. For non-locking enveloping worm and rack transmission for concave surface it will be defined as parts A and B but for convex surface just part A. For self-locking enveloping worm and rack transmission for concave and convex it will be defined as part B. For repositioning of the enveloping worm surface we can use more than one combination from FIG. 16, FIG. 17 or FIG. 18. Let's describe it in more detail. The modification of the convex geometry of the enveloping worm with surface 15 is shown in FIG. 15. Said thread with concave shape is modified by repositioning its surface from the original position. This will be done by turning around axis Y in the negative direction (approximately 1 degree) and then transferring along axis Y in the negative direction (approximately 1 mm). This is (−A52) in FIG. 16, (−B52) in FIG. 17 and (−AB52) in FIG. 18. For the concave surface of the thread from FIG. 7 this will be done by turning around axis Y in the positive direction and then moving along axis Y in the positive direction. This is (A52) in FIG. 16, (B52) in FIG. 17 and (AB52) in FIG. 18. For enveloping worms that have different directions of thread rotation (counterclockwise versus clockwise) the directions of turning and transferring should be opposite. The reposition of the enveloping worm surface could be done by additional transfer and turning. This will be done by turning around axis Y in the negative direction, then transferring along axis Z in the negative direction and then transferring along axis X in-the negative direction.

The reposition of worm thread surfaces from their original (not modified) position could be done using any of the above transferring and/or turning or different combinations of moving and turning. The change of thickness along the worm thread could be the result of some of the modifications. For some modifications worm thread has gradually changing thickness which is wider in the smaller lead angle part of the enveloping worm. It is not necessary to turn worm thread surface exactly around above specified axes. It could be different axis, positioned parallel and close to above X, Y, Z and W axes. It is not necessary to transfer worm thread surface exactly along above specified axes. It could be different axis, positioned parallel and close to above X, Y, Z and W axes. The modification of the enveloping worm thread is done without any deformation or alteration of original geometry of the original enveloping thread. The topology of enveloping thread surfaces is not changed. Changes are present only in the position of repositioned surfaces of enveloping worm thread from original position that were defined by generating original surfaces of the enveloping thread. The result is a new enveloping worm rack transmission shown in FIG. 1 where enveloping worm 1 is in mesh with rack 2 and where enveloping threads of an enveloping worm were modified by changing positions of surfaces according to the principles of the present invention.

The same principals, as described above for the repositioning of working convex and concave surfaces of tapered pinion threads were used for new spiral bevel pinion and rack transmission and for new hypoid pinion and rack transmissions. They have threads in the topology very close to the enveloping worm thread with 90 degrees or lees than 90 degrees of revolution. Each thread has concave surface on one side and convex surface on an opposite side. Generation of rack teeth could be done by variable or constant ratio.

The new invention has non obvious usage of well known enveloping worm, spiral bevel gear or hypoid pinion gear. By repositioning the enveloping worm thread from its original position, were it was generated by rolling of cutting edge around base circle into arrangement with rack, line or even area of contact mesh with rack teeth becomes possible. To use these tapered threads in different designs of new rack and pinion transmission the surfaces of the thread can be repositioned into new positions with the same topology of surfaces. Surface repositioning of spiral bevel or hypoid pinions could be made by the same principals as described above for enveloping worm in rack and pinion transmission.

In the present application, it is surface-to-surface contact between the tapered thread of pinion and rack teeth that increases the torque capacity of the new rack and pinion transmission.

The efficiency of the new rack and pinion transmission is greater than in well-known worm or helical pinion rack and pinion transmissions.

For the same pinion size, this invention can provide up to 30% the torque capacity of conventional rack and pinion transmission.

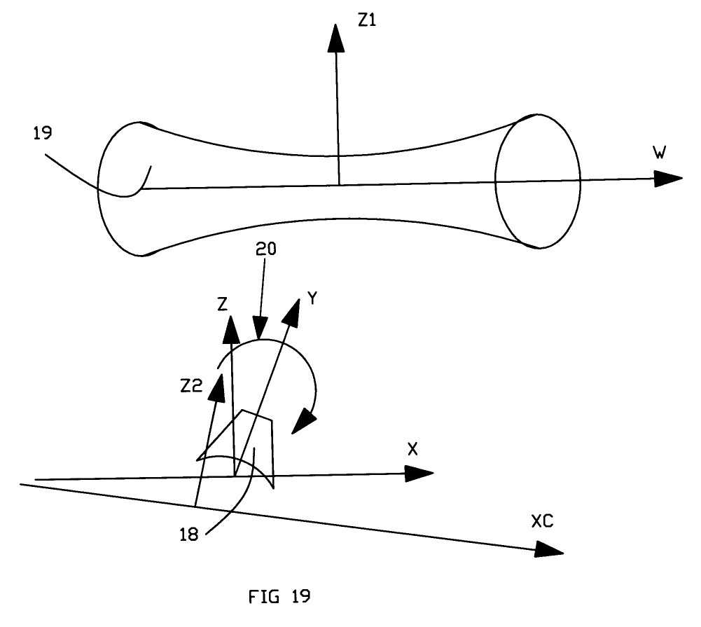

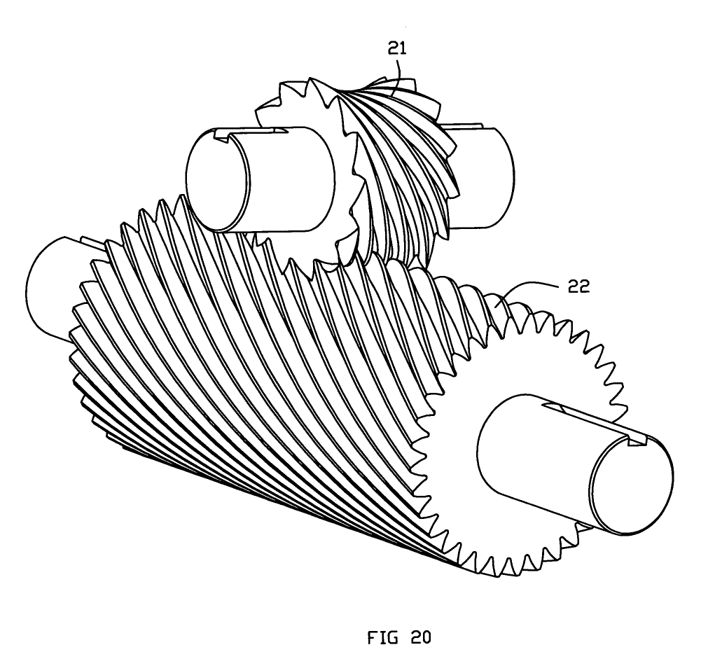

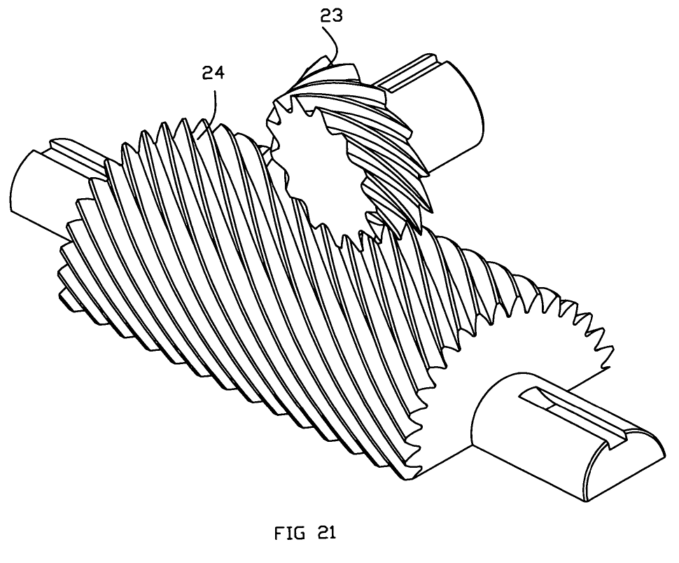

FIG. 19 shows an example of machine setting for manufacturing modified enveloping worm.

X, Y, Z is base coordinate system, placed in the middle of the base circle for cutting tool 18.

W is axis of rotation of worm's blank 19. Vector Z1 normal to cutting plane ZX is made from intersection of axis Y with axis W. Position 20 is the direction of turning to reposition cutter 18. To machine modified convex thread of the enveloping worm we need to turn cutter 18 around Y axis and then transfer along Y axis. New cutting plane for machining convex surface is defined by XC and Y axes and new position of vector Z1 is defined by Z2.

This set-up can be used to machine just one surface of enveloping worm thread, concave or convex. To machine the opposite surface (concave or convex) there will be a different set-up.

Machining the tapered thread to modify the enveloping worm, spiral bevel or hypoid gears by using Gleason or Oerlicon machines requires defining trajectory of motion for a cutting tool in order to generate concave and convex surfaces of the enveloping worm thread. Modified surfaces of thread could be designed and then manufactured using derived equations of the repositioned surfaces or by computer modeling or special setup of a machine according with the principles of present invention

Rack teeth generation (by hobing) could be used by a cutting tool with one thread or more than one of modified threads. If we use computer simulation to generate data we can use the same principles of reposition of predetermined enveloping worm surface into new position. Then we can generate a computer model of the rack by using already defined enveloping worm thread surfaces.

FIG. 22 shows a rack and pinion with the angle Ω between pinion 23 axis 25 of rotation and a rack's 23 direction of movement 26 is 90 degrees or less.

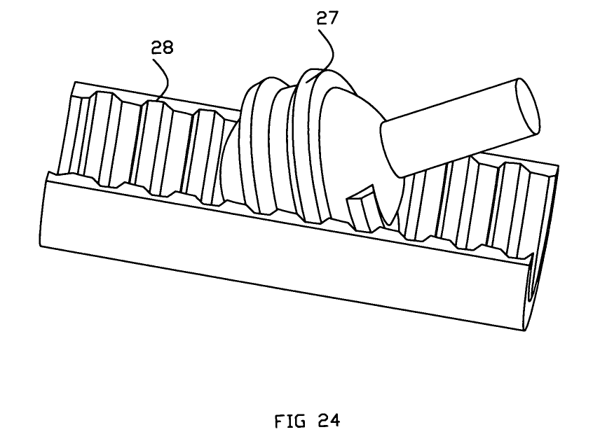

FIG. 23 shows pinion 27 and rack 28 with an angle between pinion 27 axis of rotation and a direction of movement of rack 28 is zero degrees. Pinion 27 on this figure is enveloping pinion with inverted envelope shape.

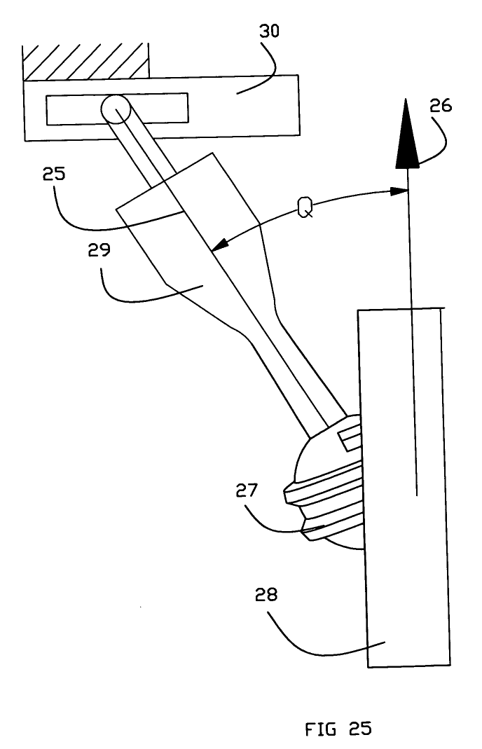

FIG. 24 shows rack 28 and pinion 27 with an angle between pinion 27 axis of rotation and a direction of movement of rack 28. Pinion 27 on this figure is enveloping pinion with inverted envelope shape.

FIG. 25 shows rack 28 and pinion 27 with variable angle Q between pinion 27 axis of rotation 25 and a direction of movement 26 of rack 28. Pinion 27 on this figure is enveloping pinion with inverted envelope shape. In the example of mechanism with variable angle Q motor 29 connected to pinion 27 and to linear guide 30. Rotation of the motor 29 makes linear and angular motion of the pinion 27 relative to the grounded guide 30.

The basic inventive system of the present invention can be reconfigured into many different mechanical transmissions. For example, it can be used in steering systems of vehicles, power windows, escalator drive, automotive power seats, metalworking machine drives and more.

### General Advantages of Rack and Enveloping Worm or Tapered Pinion Transmission

The above described rack and pinion transmission has an advantage in transmitting more power with smaller size. It is a compact alternative for conventual's rack and pinion transmission especially in power steering system.

The invention has high torque/force capacity due to surface to surface contact mesh that reduces contact stresses. Contact pattern of motion along the rack tooth line: from the left to the right or from the right to the left depending on the direction of rotation. It has better lubrication condition (suction vs. squeezing out) that may reduce the cost in assembly and increase driving efficiency. In automotive power train applications like electrical power steering system it saves space up to 30% and significantly reduces weight. It will work in power windows and power seats and many industrial applications. Most of the time each thread of the tapered pinion is in mesh longer than any other known gear's pinions. It reduces impact of engagement and disengagement, increases the contact ratio and makes quieter motion.

In the invention being thus described, it is obvious that the same may be varied in many ways. Such variations are not to be regarded as a departure from the spirit and scope of the invention, and all such modifications as would be obvious to one skilled in the art are intended to be included within the scope of the following claims.

1. Rack and pinion transmission comprising an enveloping worm in the engagement with a mating rack.

2. Rack and pinion transmission as recited in claim 1 wherein said enveloping worm has an inverted envelope shape.

3. (canceled)

4. (canceled)

5. (canceled)

6. (canceled)

7. (canceled)

8. (canceled)

9. (canceled)

10. (canceled)

11. (canceled)

12. (canceled)

13. Rack and pinion transmission as recited in claim 1 wherein an angle between said enveloping worm axis of rotation and direction of relative movement of said rack is variable.

14. Rack and pinion transmission as recited in claim 1 wherein an angle between said enveloping worm axis of rotation and direction of relative movement to said rack is less than 90 degrees.

15. Rack and pinion transmission as recited in claim 1 wherein said enveloping worm axis of rotation is parallel to direction of movement of said rack.
